(19) United States
(12) Patent Application Publication
(10) Pub. No.: US 2012/0126727 A1
(43) Pub. Date: May 24, 2012

(54) Sub-Nanosecond Beam Pulse Radio Frequency Quadrupole (RFQ) Linear Accelerator System

(76) Inventor: Robert W. Hamm, Pleasanton, CA (US)

(21) Appl. No.: 13/299,174

(22) Filed: Nov. 17, 2011

Related U.S. Application Data
(60) Provisional application No. 61/415,646, filed on Nov. 19, 2010.

(51) Int. Cl. H05H 9/00

(52) U.S. Cl. 315/505

(57) ABSTRACT

Sub-nanosecond single ion beam pulses are generated by means of one embodiment of the invention. In this embodiment, an ion source provides ions to a radio frequency quadrupole linear accelerator comprising electrodes. A power source is used to apply radio frequency alternating currents to the electrodes. A device is used to inject ions from the ion source to the accelerator, causing the accelerator to provide only a single sub-nanosecond output beam pulse at a time.

### CROSS-REFERENCE TO RELATED APPLICATION

This application claims priority to U.S. Provisional Application No. 61/415,646 filed on Nov. 19, 2010, which is incorporated herein by this reference in its entirety.

### BACKGROUND OF THE INVENTION

This invention relates to systems for providing ion pulses and more particularly to a Radio Frequency Quadrupole (RFQ) linear accelerator system capable of producing a single beam pulse of sub-nanosecond width. Linear accelerators are known as linacs to those skilled in the art.

Almost all particle accelerators produce energetic streams of charged particles by transferring energy to the particles through the use of electric fields. Such energetic particle beams are useful in a variety of applications, from basic physics research to the treatment of cancer. In these as well as other applications, the energy put into the charged particles by the electric fields is carried by the moving stream and deposited in a material to cause the desired effect. The particles carrying the energy can be either electrons or much heavier ions.

For ion accelerators, these charged particles are created inside a small chamber by an ion beam source, such as a gaseous electric arc, a plasma discharge such as that created in a fluorescent light bulb when it is turned on. The ions created in this chamber are formed into a coherent stream (“beam”) when they exit through a small aperture and are accelerated by a voltage into an evacuated tube. This ion beam is then injected into a particle accelerator if a higher kinetic energy is desired. Several types of accelerators can be used to create high-energy, charged-particle beams, and these are generally described by their geometries as being either linear or circular. There are a number of accelerators that have been developed to produce sub-nanosecond beam pulses:
1) Electrostatic accelerators (tandems) were used to produce sub-nanosecond pulses as early as the 1960's for use in nuclear physics measurements. These systems are very large and require several bunchers to produce the short beam pulses. See Naylor et al., The Production of Intense Nanosecond and Subnanosecond Beam Pulses From Tandem Accelerators, IEEE, Vol. 12:3 pp. 305-12, June 1965. In this scheme, two rf bunching cavities are used to introduce an energy spread in the beam before injecting the beam into an electrostatic accelerator. The energy spread resulted in a bunching of the beam after a long drift. The sharpness of the bunch was enhanced by the use of a magnetic analysis system after the acceleration. Nanosecond beam pulses are achieved and it was proposed to use post-acceleration to get bunch time spreads lower than this.
2) As early as 1975, such bunched beams were produced using a tandem accelerator for injection into an rf linac, as reported in the attached paper from Bollinger et. al., Ultra-Short Pulses of Heavy Ions, IEEE Transactions on Nuclear Science, Vol. NS-22, No. 3, pp. 1148-52, June 1975. This system is similar to the one above in Naylor et al. Four rf bunching cavities are used (two before the acceleration in a tandem electrostatic accelerator and two after it) for slower moving heavy ions to get very short pulses for injection into a rf linac. This technique required numerous elements to achieve the results.
3) Single sub-nanosecond pulse linacs have also been developed for electrons. In these cases, the short pulse is achieved easily by pulsing the electron emission of the electron gun used to inject into the linac. Very accurate timing systems that use a precise crystal oscillator or a mode locked laser have been developed in order to time the injected pulse into the linac, as described in the attached paper from Kashiwagi et. al., New Timing System For the L-Band Linear Accelerator at Osaka University, pp. 208-10, APAC 2007. A very short laser pulse is used to irradiate a photocathode material to generate ps electron pulses for injection into an rf linac. The length of the laser pulse is selected to be no longer than one rf cycle of the linac.

The linear accelerator can be either an electrostatic or a radio frequency (rf) device. All previous rf linear accelerators were able to accelerate charged particles to high energies, but were very large structures that were inefficient at maintaining a coherent beam within the structure (particles of like charge repel each other) at lower kinetic energies. Thus they could obtain only limited current (defined as the number of ions passing through a plane per second). What was badly needed was a compact device with the ability to maintain a high-current beam at low kinetic energy and accelerate it to provide more usable ions at the energies that could be used by conventional systems.

The development of the RFQ linac was in direct response to this need. The RFQ and the design codes developed at Los Alamos have proliferated around the world. There are currently no Radio Frequency Quadrupole (RFQ) accelerators available on the commercial market that offers the capability of single sub-nanosecond pulses for ions,

The only RFQ system that is being developed to produce a nanosecond beam pulse is described in the paper by Meusel et. al. from the Linac 2006 conference. See Meusel, et al., Development of An Intense Neutron Source “Franz” in Frankfurt, Proceedings of LINAC 2006. This system however, does not produce a single beam pulse from the RFQ, but a train of 7 pulses each about 1 nanosecond in width that are then combined in a magnetic spectrometer system by varying their flight paths so that they arrive at the target at the same time to produce a final combined single pulse. The beam entering the RFQ is swept across a slit with a deflecting magnet to produce a dc pulse of a few tens of ns that is then bunched in the 175 MHz RFQ in the “normal” mode of operation to form as many as 10-12 micropulses of beam. A buncher cavity is used after the RFQ to further bunch these micropulses before they are accelerated further in another rf linac. After the full acceleration, another deflector is used with a slit to select the 7 pulses going into the magnetic spectrometer for “stacking” at the neutron target.

It is desirable to provide an improved RFQ linear accelerator system capable of producing a single beam pulse of sub-nanosecond width at a time.

### SUMMARY OF THE INVENTION

In one embodiment of the invention, to provide sub-nanosecond single ion beam pulses, an ion source is used to provide ions to a radio frequency quadrupole linear accelerator comprising electrodes. A power source is used to apply radio frequency alternating currents to the electrodes. A device is used to inject ions from the ion source to the accelerator, causing the accelerator to provide only a single sub-nanosecond output beam pulse at a time.

All patents, patent applications, articles, books, specifications, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

### BRIEF DESCRIPTION OF THE DRAWINGS

FIG. 1 is a perspective view of a conventional radio frequency quadrupole structure.

FIG. 2. is a perspective view of a RFQ linac structure.

FIG. 3 is a cross-sectional view of a portion of the RFQ linac structure of FIG. 2 along the x-z plane and shows the minor symmetry of the opposite poles about the beam axis.

FIG. 4 is a graphical plot of periodic macropulses together with an exploded view of the pulses within one of the macropulses at an edge of the one macropulse to illustrate the time structure of the output of a conventional 425 MHz RFQ linac.

FIG. 5 is a block diagram of an apparatus providing sub-nanosecond single ion beam pulses including a RFQ linac structure to illustrate an embodiment of the invention.

FIG. 6 is a block diagram to illustrate a system including a circuit for synchronizing the deflection mechanism of FIG. 5 to cause the RFQ linac structure to generate a single beam pulse of sub-nanosecond width at a time.

FIGS. 7A is a schematic view of the deflection mechanism and the RFQ linac structure of FIG. 5 to illustrate the operation of the deflection mechanism and effect of deflection on an ion beam. FIG. 7B is a graphical plot of the RFQ acceptance phase space illustrating the acceptance aperture of the RFQ of FIG. 5, and of the deflected and undeflected beam phase spaces.

FIG. 8 is a graphical plot of RFQ linac modulation and other parameters as a function of RFQ linac cell number to illustrate another embodiment of the invention.

FIG. 9 shows the beam transmission and longitudinal emittance of the RFQ calculated as a function of the intervane voltage.

FIG. 10 is a graphical plot of the RFQ cavity field measured using a pickup loop in the cavity and the RFQ output beam measured with a current toroid for illustrating the actual operation of an REQ with a “short” beam macropulse.

FIG. 11 is a graphical plot of the radio frequency (hereinafter “rf”), injector and deflector voltage signal waveforms to illustrate the operation of the injector and deflector.

FIG. 12 is a graphical plot of the rf and deflector voltage signal waveforms showing at higher resolution of a timing relationship between the rf and deflector voltage signal waveforms for illustrating an embodiment of the invention.

FIG. 13 is a schematic view of electrodes in an energy transport system for transporting ions from an ion source in an ion beam to a RFQ linac structure.

FIG. 14 is a schematic view of the pair of deflection plate electrodes of FIG. 6 and of the DC and voltage pulses applied to them to illustrate an embodiment of the invention.

Identical components in this application are labeled by the same numerals.

### DETAILED DESCRIPTION OF EXEMPLARY EMBODIMENTS

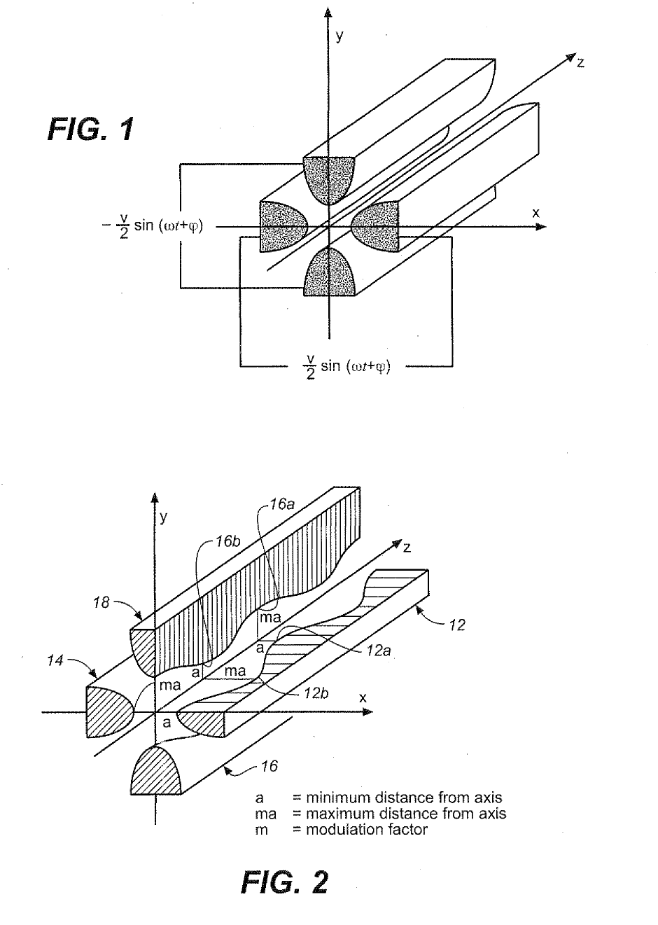

FIG. 1 is a perspective view of a conventional radio frequency quadrupole structure useful for illustrating an embodiment of the invention. Since the four electrodes are of uniform dimensions along their lengths, electric field resulting from voltages applied to the four electrodes will only be in transverse (i.e. transverse to the lengths of the electrodes and to the ion beam axis along the z axis) directions, so that there is no longitudinal (i.e. direction parallel to the lengths of the electrodes and to the ion beam axis along the z axis) force on ions between the four electrodes. Hence the ions will not experience longitudinal force on them and will not accelerate in the longitudinal direction.

FIG. 2. is a perspective view of a RFQ linac structure useful for illustrating an embodiment of the invention. In contrast to the structure of FIG. 1, the four electrodes (two horizontal electrodes 12, 14 and two vertical electrodes 16, 18) have modulated surfaces along the beam axis. Application of rf power to the four electrodes will generate longitudinal electric field and force on ions between the four electrodes. The rf field so applied will focus, bunch and accelerate the ions along the beam axis in the. RFQ linac structure. For a more detailed explanation of the RFQ linac operation, please see Chapter 8 in the book “RF Linear Accelerators” by Thomas Wangler, Wiley-VCH Verlag GmBh & Co., 2008, pp. 232-281. The four vanes define a cavity therein. A cross-sectional view (in reference to the ion beam axis) of this cavity is illustrated in FIG. 8.8 in Chapter 8 in RF Linear Accelerators by Thomas Wangler.

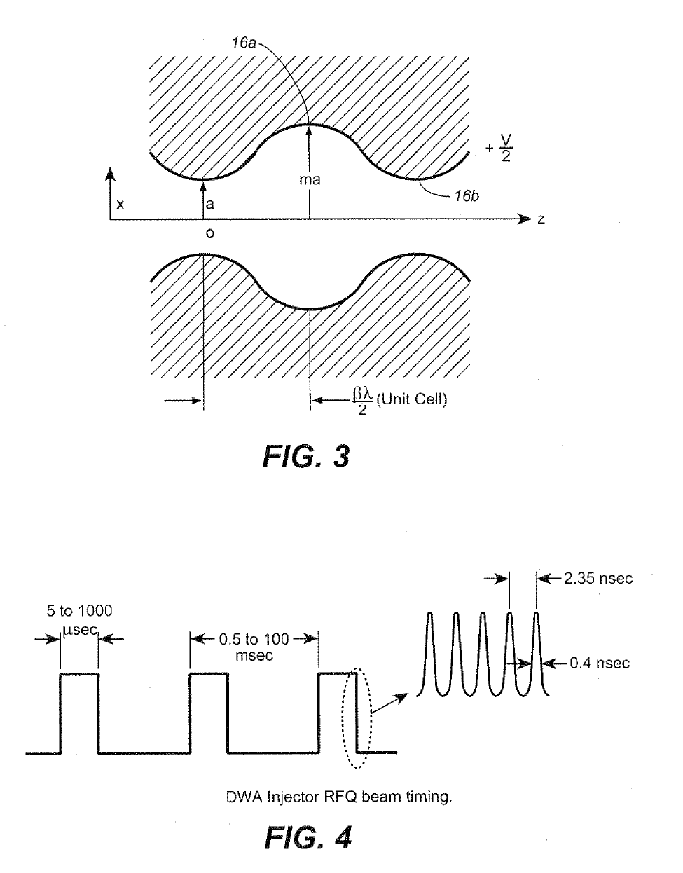

The modulation of the four electrodes is defined by the radius of the electrode surface at different points along the length of the electrodes. As shown in FIG. 3, the minimum radius of the electrode tip surface is indicated as a, and the maximum radius of the electrode tip surface is indicated as ma, where m is the modulation of the surface. As shown in FIGS. 2 and 3, the minimum distance between the electrode surface and beam axis is indicated as a, and the maximum distance between the electrode surface and beam axis is indicated as ma. As shown in FIG. 2, the distance a between the two horizontal electrodes 12, 14 is minimum at 12a when the distance ma between the two vertical electrodes at 16a is maximum, and vice versa (at 12b, 16b). A unit cell is defined, as illustrated in FIG. 3, by the separation between a location on the electrode surface of one of the electrodes where the distance between the surface of such electrode and beam axis is maximum (e.g. 16a) and a neighboring location on the electrode surface of such one electrode where the distance between the electrode surface and beam axis is minimum (e.g. 16b).

A timing structure of a pulsed RFQ linac structure is illustrated in FIG. 4. As indicated in FIG. 4, within each macropulse at the output of the RFQ linac, the beam has the frequency structure of the cavity and within each rf cycle the beam “micropulse” may have a time structure of a nsec or a few tenths of a nsec, depending on the cavity frequency and the final rf phase width of the beam at the exit of the structure. For example, where the rf operating frequency is 425 MHz, as in one embodiment of the invention, the RFQ cavity has a Q of ˜7,000 and a cavity fill time of 5-1.0 μsec. The cavity is pulsed at a repetition rate that can vary from 10 to 2000 Hz with an rf pulse width of 15 to ˜1000 μsec. The upper limits to these parameters are normally due to the limits of the rf power amplifier. This timing structure then provides an output beam “macropulse” width from 5 to 1000 μsec as indicated in FIG. 4. Within each macropulse the beam has the frequency structure of the cavity (425 MHz) and within each rf cycle the beam “micropulse” has a time structure of a few tenths of a nsec, depending on the final rf phase width of the beam at the exit of the structure.

In other words, while the pulsed RFQ linac structure is capable of delivering micropulses having a time structure of a few tenths of a nsec, these micropulses are delivered close together as a macropulse. In many potential applications of the RFQ linac, such as in neutron production for time-of-flight measurements, the delivery of a single micropulse at a time is desired instead of a sequence of micropulses that are close together in time in a macropulse. However, it is very difficult to filter or block all of the micropulses in a macropulse except for one micropulse so as to provide at the output a single micropulse at a time that is not close in time to any other micropulse. It is desirable in potential applications to have only one micropulse delivered from each short macropulse, with the repetition frequency of the macropulses determining the time between the single micropulses.

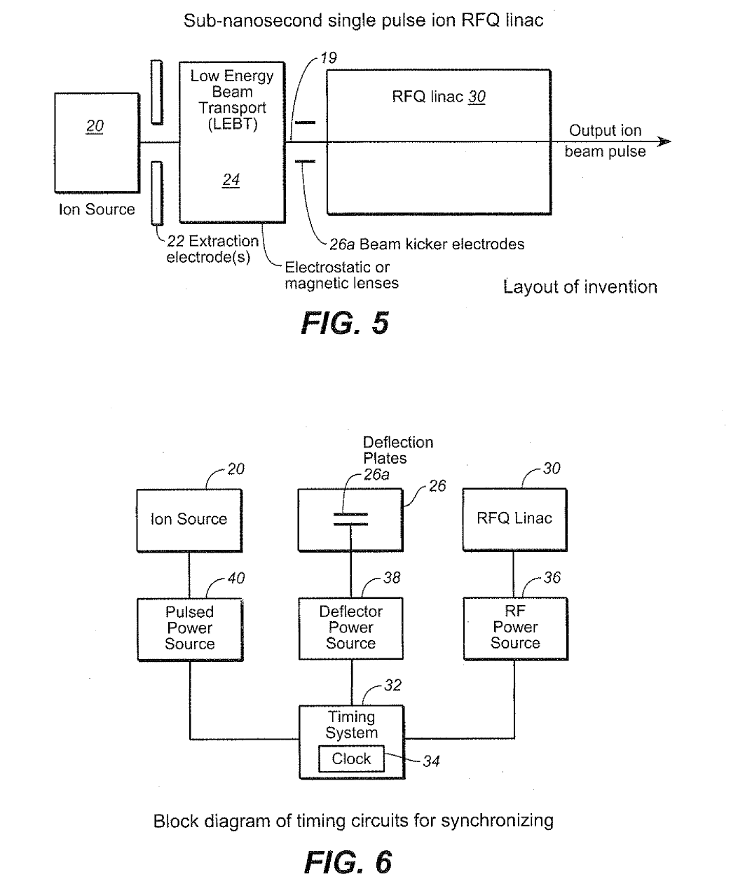

One embodiment of the invention is based on the recognition that each of the micropulses in the macropulse is generated in response to a cycle of the rf power applied to the RFQ linac structure, and that by deflecting the output beam in synchronism with the rf cycle, it is possible to cause the RFQ linac to output a single ion pulse at a time. It is impractical to apply rf power of a single cycle to the RFQ linac structure, so that the multiple cycles of rf power applied cause multiple micropulses to be applied together in a macropulse. This problem is solved by means of the apparatus shown in FIGS. 5 and 6, in one embodiment of the invention, by gating the ion beam so that only the ions in the beam that will be let through the RFQ linac during one of the rf power cycles are injected to the RFQ linac structure, so as to provide a single micropulse at a time as the RFQ linac structure output.

FIG. 5 is a block diagram of an apparatus providing sub-nanosecond single ion beam pulses including a RFQ linac structure to illustrate an embodiment of the invention. FIG. 6 is a block diagram to illustrate a system including a circuit for synchronizing the deflection mechanism of FIG. 5 to cause the RFQ linac structure to generate a single a beam pulse of sub-nanosecond width at a time.

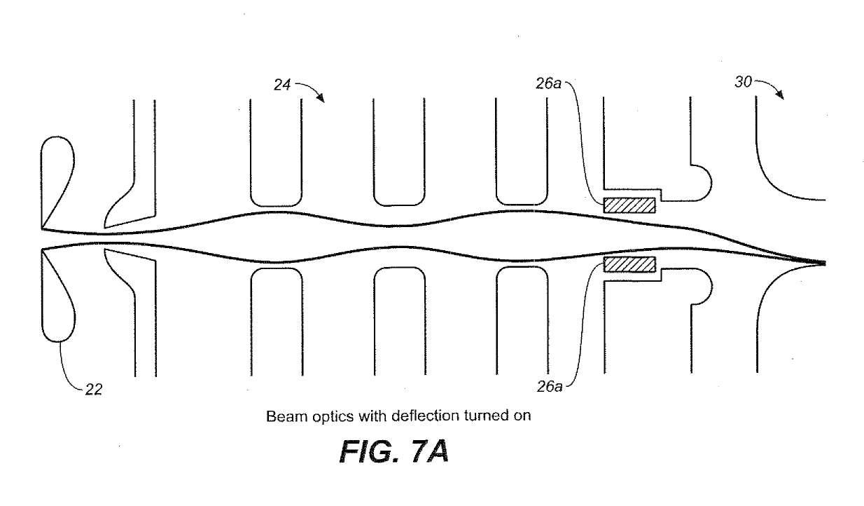

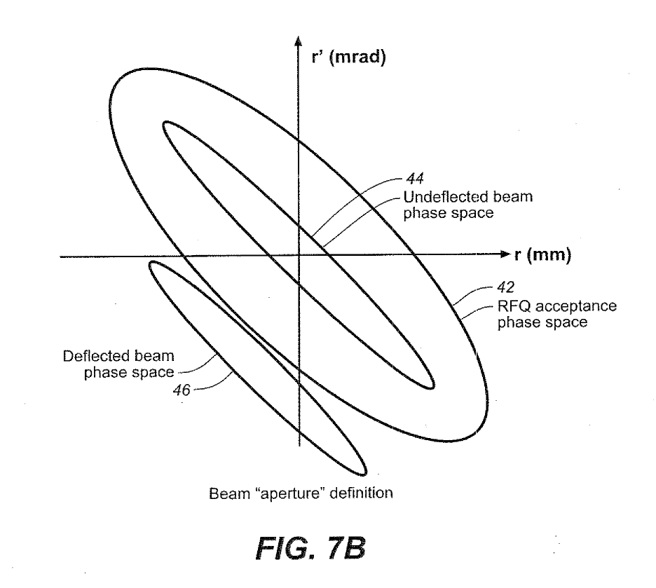

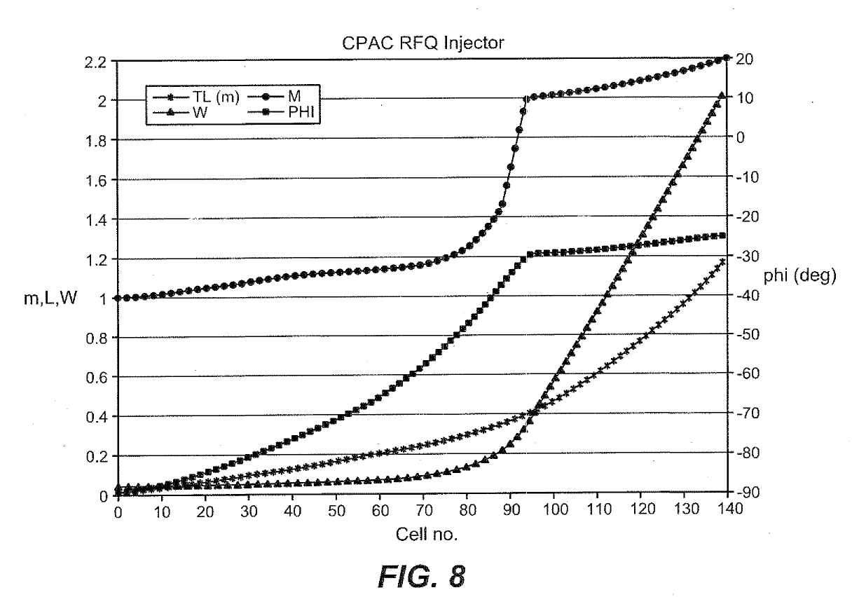

As shown in FIG. 5, an ion source 20 provides ions. Source 20 may include an ion source such as a source employing gaseous electric arc, one example being a fluorescent light bulb type arc generating ions by means of a plasma discharge such as that created when it is turned on. In the description below, protons are used, it being understood that the invention is applicable to other types of ions as well and not limited to protons. The ions generated by source 20 are extracted by extraction electrodes 22, causing the ions to accelerate to a higher energy, such as around 35 keV. Where the ions are protons, the beam may be as much as a 50 mA proton beam at an extracted energy of around 35 keV. These ions are then focused by means of a Low Energy Beam Transport (LEBT) 24 to provide a beam 18 passing between a deflection mechanism 26, which may include two defection plates, or beam kicker electrodes 26a. In one embodiment, a deflection voltage is applied across the plates 26a so that the beam is deflected away from the aperture of the RFQ linac 30, so that no ions will be let through the linac 30, as illustrated in FIG. 7A. This situation will continue until a control voltage is sent to the plates 26a to stop applying the deflection voltage. When this happens, the ions in the beam are no longer deflected by plates 26a and pass to the input port of the RFQ linac 30, as illustrated in FIG. 7B. The control voltage so applied to the plates 26a is synchronized with one of the rf cycles of rf power applied to the RFQ linac 30, so that the RFQ linac 30 will bunch and accelerate only such ions and provide a single subnanosecond ion pulse each time the control voltage is applied.

FIG. 6 shows the system for generating the control voltages. A timing system or controller 32 with clock 34 controls a RF power source 36 that applies rf power to the RFQ linac 30, a deflector power source 38 that controls the voltage across the deflection plates 26a and pulsed power source 40 that controls the ion source 20. Upon initiation, timing control 32 applies signals to power sources 36, 38 and 40, causing rf power to be applied to the RFQ linac 30, and power applied by sources 38 and 40 causing ion source 20 to emit an ion beam for a given duration, and deflector plates 26a to deflect the ion beam passing between plates 26a through the application of a dc bias voltage by source 38.

FIG. 7A illustrates the ion beam path in the LEBT and as it enters the RFQ aperture under the above described conditions. FIG. 7B is a graphical plot of the RFQ acceptance phase space illustrating the acceptance aperture of the RFQ 30. The RFQ acceptance phase space defines the spatial boundary 42 on a plane perpendicular to the beam axis at the input port of the RFQ 30, where ions entering the input port at locations within this boundary (e.g. undeflected beam phase space 44) will appear at the output of the RFQ 30, whereas ions entering the input port at locations outside this boundary (e.g. deflected beam phase space 46) will not appear at the output of the RFQ 30. As illustrated in FIG. 7A, with the above described signal and voltage conditions, the ions are deflected by plates 26a to reach the vanes of the RFQ, so that the ions will be deflected to locations outside this boundary and appear as deflected beam phase space 46 as shown in FIG. 7B. This means that the ions will not appear at the output of the RFQ 30.

This situation continues until a sharp rf pulse is applied by deflector power source 38 to plates 26a to cancel the dc bias voltage that causes the ion beam to be deflected. When this happens, the ion beam is no longer deflected, and it will be characterized by the undeflected beam phase space 44 instead of the deflected beam phase space 46 shown in FIG. 7B. Hence, the ions will appear at the output of the RFQ 30.

One application for an embodiment of the invention is for the Dielectric Wall Accelerator (DWA), such as those used in proton therapy for cancer treatment. While there are several plasma ion sources that can produce the proton beam required for the RFQ injector linac, the ion injector embodiment specified for the DWA injection system is a standard duoplasmatron.

Beam dynamics calculations were performed for the proposed RFQ design to develop as short an output beam pulse as possible, while still achieving the specified output beam parameters. In addition, the RFQ linac was designed to be as compact as possible while minimizing the rf power to provide operational reliability and compatibility with an existing commercial rf amplifier. This is also the basis for choosing the RFQ operating frequency of 425 MHz, although the RFQ could be designed for slightly better performance at a higher frequency of 500 MHz. After the RFQ design was completed, the requirements for the ion source were considered and a preliminary design was completed for the beam transport system to inject the proton beam extracted from it into the REQ linac.

TABLE II
Advantages of using an RFQ Injector for the DWA

| Advantage | Explanation |
|---|---|
| High Space Charge | The alternating radio frequency voltage on the electrodes produces a strong |
| | electrostatic quadrupole focusing channel that can handle the large space charge |
| | input beam required for the DWA. |
| DC Beam Injection | Because of the electrostatic focusing, the RFQ is also the only linear accelerator |
| | that can accept a low energy CONTINUOUS beam of particles extracted |
| | directly from an ion source at a low voltage. |
| Effective Bunching | The longitudinal modulation of the electrodes produces a field in the direction of |
| | propagation of the beam which can be used to efficiently bunch the beam and |
| | accelerate it with a high gradient. This adiabatic bunching preserves beam |
| | quality and yields high capture efficiency, with a factor of 6-10 compression of |
| | the time structure of the beam. |
| Simple Operation | The focusing, as well as the bunching and acceleration are performed |
| | simultaneously by the RF fields created from the electrodes, so the RFQ is a one |
| | “button” machine that is easy to operate (the transverse and longitudinal |
| | dynamics are machined in the electrode microstructure) and quite reliable. |
| Beam Purity | The RFQ is designed as a fixed velocity profile accelerator, so only the design |
| | particle is accelerated for injection into the DWA. |

Because of these properties, the RFQ linac typically captures >80% of a dc proton beam injected into it at a few 10's of keV and provides micro-pulses of 0.40 nsec that have been bunched by a factor of ˜6 from the dc current and have an energy spread of ±1%. However, the flexibility of the design also allows a trade-off of output beam properties to vary these values.

### RFQ Linac Physics Design

The proton RFQ linac developed for this embodiment has the design parameters listed in Table III. This RFQ will accelerate the protons extracted from the injector at 35 keV to a final energy of 2 MeV. The current limit of the structure is almost twice the output current required for certain applications using the DWA, giving ample margin for the structure's performance. The rf power for the structure is modest and available from a commercial unit. A single 3⅛″ coaxial drive loop couples the rf power into the RFQ at its operating frequency of 425 MHz. The final physical length of the RFQ vacuum chamber may be slightly longer than the indicated structure length.

TABLE III
DWA RFQ Parameters

| Operating Parameter | Value |
|---|---|
| Operating frequency (MHz) | 425 |
| Injection energy (MeV) | .035 |
| Final beam energy (MeV) | 2.0 |
| Design input current (mA) | 50 |
| Current limit (mA) | 85 |
| Transmission at 50 mA (%) | 79 |
| Input transverse emittance-norm (π mm-mrad) | 0.3 |
| Output emittance-norm (π mm-mrad) | 0.3 |
| Bore radius (mm) | 1.90 |
| Peak RF field surface gradient (MV/m) | 45.6 |
| Structure length (m) | 1.1164 |
| Pulsed structure power (kW) | 215 |
| Pulsed beam power (kW) | 50 |
| Pulsed RF input power (kW) | 265 |

This RFQ structure can accept the proton beam extracted directly from a plasma ion source at energies of 35 kV and the beam can be effectively focused at such low injection energy with electrostatic lenses. Since the electrostatic focusing proposed in the LEBT is well demonstrated to be able to match an ion beam into an RFQ, the RFQ structure was designed and the beam dynamics calculations were done assuming a matched beam as the input into the RFQ. The design parameters of the final RFQ are shown as a function of the cell number in FIG. 8, with M being the vane modulation, W the beam energy, TL the vane length and PHI the phase of the synchronous particle with respect to the peak of the rf period.

After the final RFQ design had been completed the Los Alamos code PARMTEQ was used to perform a number of beam dynamics calculations of the output properties as a function of the intervane voltage (rf power) to predict the performance.

### Beam Timing

The typical timing structure of a pulsed RFQ linac structure is illustrated in FIG. 4. At an rf operating frequency of 425 MHz, the RFQ cavity has a Q of ˜7,000 and a cavity fill time of 5-10 μsec. Hence, the cavity is usually pulsed at a repetition rate that can vary from 10 to 2000 Hz with an rf pulse width of 15 to ˜1000 μsec. The upper limits to these parameters are normally due to the limits of the rf power amplifier. This timing structure then provides an output beam “macropulse” width from 5 to 1000 μsec as indicated in FIG. 4. Within each macropulse the beam has the frequency structure of the cavity (425 MHz) and within each rf cycle the beam “micropulse” has a time structure of a few tenths of a nsec, depending on the final rf phase width of the beam at the exit of the structure.

While the multiple cycles of rf power are applied at a repetition rate from 10 to 2000 Hz in the above example, it will be understood that the technique herein for generating a single micropulse is applicable where rf power is applied continuously to the RFQ linac 30. Where rf power is applied continuously to the RFQ linac 30, the repetition frequency of the application of the voltage (that is, the time intervals between the repeated applications of such voltage) that cancels the deflection voltage applied to the deflection plates 26a determines the time between the single micropulses.

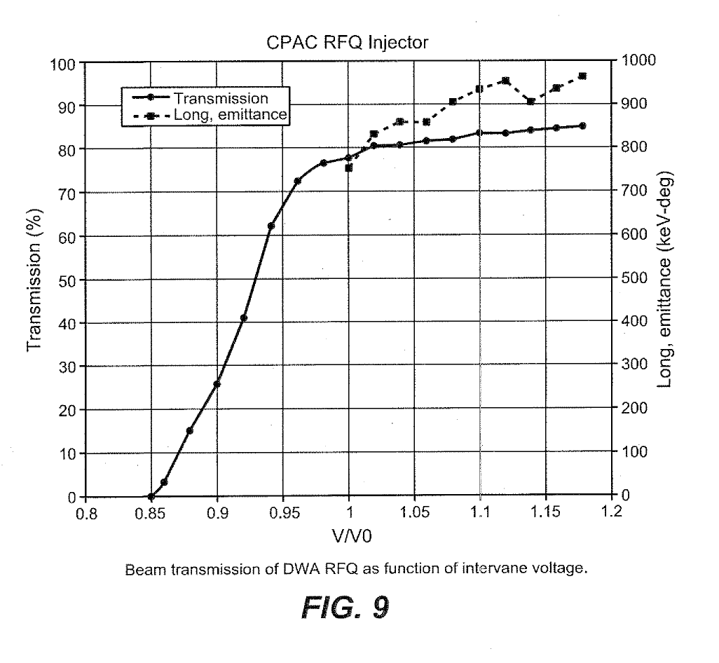

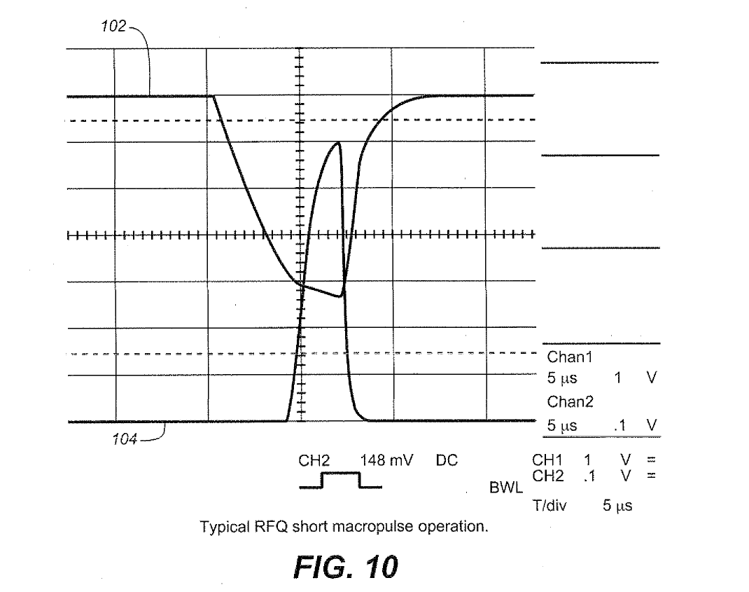

FIG. 10 shows the actual operation of an RFQ with a “short” beam macropulse. The curve 102 is the RFQ cavity field measured using a pickup loop in the cavity and the curve 104 is the RFQ output beam measured with a current toroid. The slow rise time of the beam pulse is due to the rising rf field, which causes a rise in the beam current as seen in FIG. 9, and to the time constant of the current toroid.

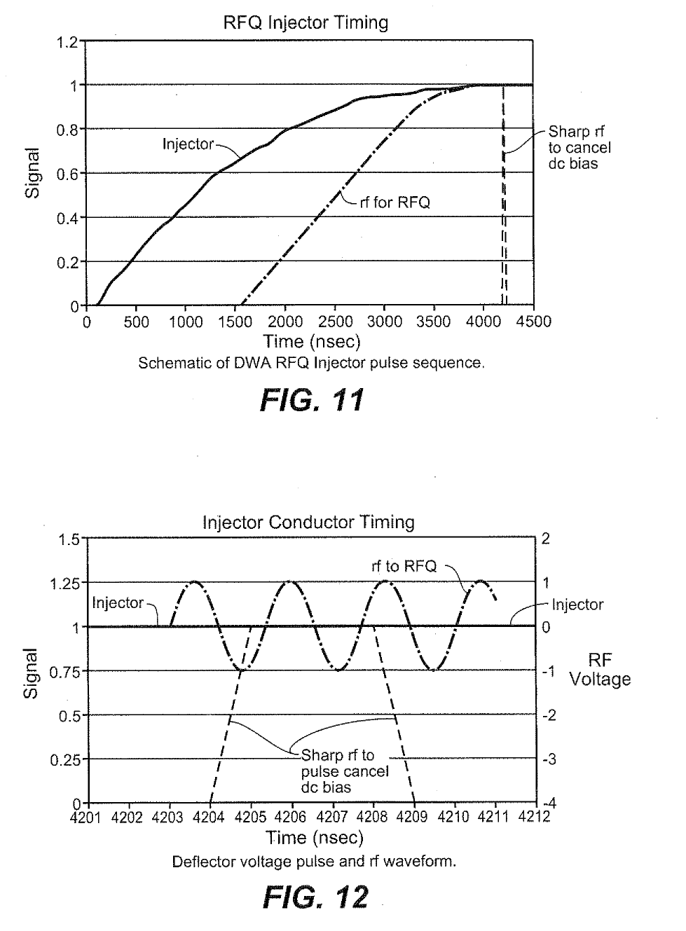

For injection of a beam pulse from the RFQ into the DWA, only a single macropulse will be required. This operation will require timing accuracy of a few psec between the RFQ linac and DWA. The operation of the RFQ linac is indicated schematically in FIG. 11. A master clock operating at 10 Hz would start the sequence of the ion source being turned on and then the rf power being turned on to fill the RFQ cavity. During most of this pulse, the beam extracted from the ion source would be deflected by a dc voltage deflection and not injected into the RFQ structure. After the ion source and RFQ cavity have each reached a stable steady operation indicated by signal value at 1 in FIG. 11, a sharp rf signal pulse will be provided to the deflector 26 as indicated by the sharp pulse at about 4200 nsec in FIG. 11, causing a change in the dc deflection voltage as shown in FIG. 12 thereby cancelling the dc deflection voltage, to inject a beam pulse of several nsec into the RFQ, as shown in FIG. 12. With a rf frequency at 425 MHz, the rf cycle is around 2.35 nsec, as illustrated in FIG. 12. Accurate master timing signals from clock 34 in system 32, controlling the timing of the rf pulses from the rf generator in power source 36 powering the RFQ structure 30 and the sharp rf signal pulse from deflector power source 38 to the deflection plates 26a, are used to trigger a cancellation of the deflection at the site of the dc bias such that the de deflection field is cancelled for a time period that permits the input proton beam to be focused into the RFQ during one rf cycle. As a result, only a single output pulse is produced by the RFQ. The rise time and fall time of the control pulse from power source 38 as controlled or triggered by clock 34 should be approximately 1 nsec or less to insure that the beam injected into the RFQ completely fills one rf cycle, but puts very little charge into the rf cycle before and after that one. In addition to minimizing the overlap, the sweeping motion of the beam during the rise and fall of the deflector voltage will also serve to reduce the beam captured in the RFQ during that time.

The electrodes of RFQ linac 30 are designed to include four stages from the input end of the ion beam to the output end: a matching stage, a shaping stage, a bunching stage and an accelerating stage. Bunching to shorten the pulse width is achieved primarily only during the bunching stage. In previous designs, the RFQ linac 30 is typically designed to produce an output “micropulse” with a time width equal to ⅙ of the time period of a single rf cycle at that frequency. Hence, for ions that are accelerated and bunched by the RFQ linac 30 during a single cycle of the rf at 425 MHz, the single ion micropulse would have a pulse width of around 400 psec, given by 2.35/6 nsec. To further reduce the pulse width of this single micropulse, bunching is performed not only during the bunching stage but also during the accelerating stage, thereby overbunching the beam. By means of overbunching, RFQ linac 30 is able to provide a single output beam pulse of less than 300 picoseconds in width, such as a single output beam pulse of around 200 picoseconds in width. Overbunching is illustrated in FIG. 8. As illustrated in FIG. 8, the modulation M increases and the synchronous phase PHI of the bunch with respect to the rf cycle decreases monotonically from cell 90 until the ends of the electrodes near the output of the RFQ linac 30. Modulation M or m is defined above to be the ratio between the maximum radius of the electrodes to the minimum radius of the electrodes, or the ratio between the maximum distance of the electrode surface from the beam axis to the minimum distance of the electrode surface from the beam axis, as illustrated in FIG. 3. The synchronous phase PHI is defined as the phase angle between a reference particle in the beam and the peak of the rf cycle. In one embodiment, to achieve overbunching, the modulation M increases and synchronous phase decreases monotonically from cell 90 until the ends of the electrodes near the output of the RFQ linac 30.

Thus, in one embodiment of the invention, a device is provided that can produce a single pulse of ions with a beam pulse width of ˜200 picoseconds and a charge of 30 pico-Coulombs either for injection into a subsequent pulsed linac such as the DWA or for bombardment of a target material to produce a short burst of neutrons. In this embodiment, this is accomplished by the use of a radio frequency quadrupole (RFQ) linear accelerator operating at 425 MHz which has been designed to bunch a single beam pulse of 2.35 nanoseconds injected into it at the extraction energy of the ion source to a final pulse at the output energy with a width of ˜200 picoseconds with a beam transmission of >80% of the input pulse.

The main advantages of this sub-nanosecond single pulse device are its size and operational simplicity. The use of the RFQ as the accelerating structure allows one to efficiently produce a large charge in a single sub-nanosecond bunch in a compact size. The input acceptance properties of the RFQ allow a simple de bias to block acceleration of the unwanted beam, and is thus very simple to operate.

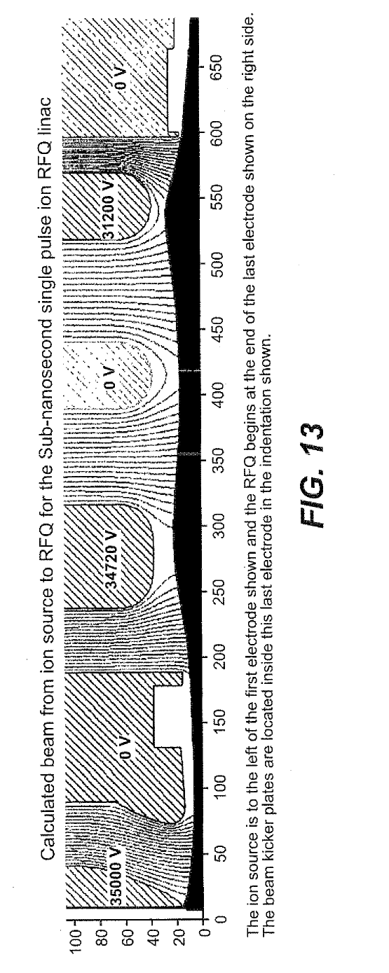

FIG. 13 is a schematic view of electrodes in an energy transport system for transporting ions from an ion source in an ion beam to a RFQ linac structure. As shown in FIG. 13, a low energy beam transport between the ion source and the accelerator for transporting ions from the ion source to the RFQ linac 30 includes two positively biased electrodes separated from one another by an electrode at ground potential. The two positively biased electrodes may be at around 34720V and 31200 V respectively. The shaded area in FIG. 13 illustrates the beam profile as it passes through the LEBT, illustrating the focusing effect upon reaching the input of the RFQ linac, of the two positively biased electrodes separated from one another by an electrode at ground potential.

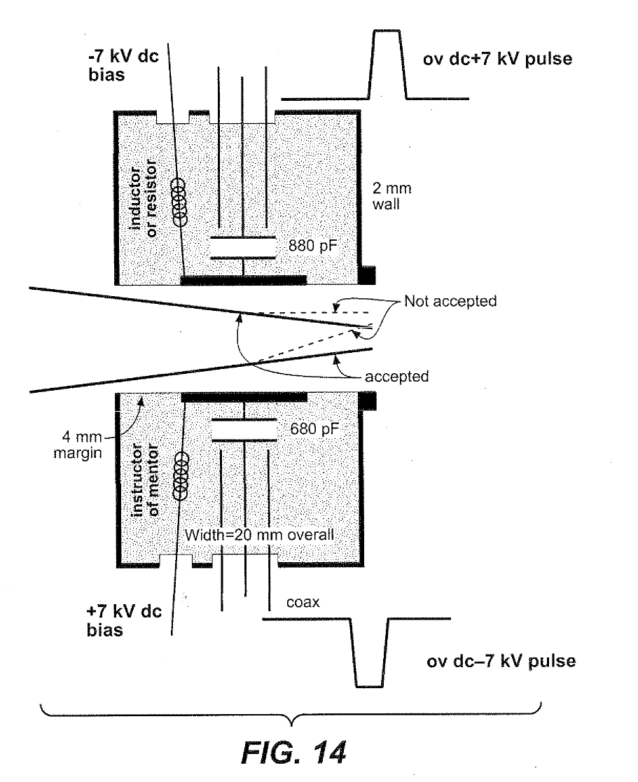

FIG. 14 is a schematic view of the pair of deflection plate electrodes of FIG. 6 and of the DC and voltage pulses applied to them to illustrate an embodiment of the invention. As shown in FIG. 14, in one embodiment, de voltages are applied to the pair of deflection plate electrodes so that the upper deflection plate electrode is at −7 kV de and the lower deflection plate electrode is at +7 kV dc. The DC bias applied across the pair of deflection plate electrodes will cause the ion beam passing through the space between the pair of deflection plate electrodes to be deflected (outside of acceptance phase space) and not injected into the RFQ linac 30 in FIG. 5. To nullify this DC bias, a +7 kV kicker pulse is applied to the upper deflection plate electrode, and a −7 kV kicker pulse is applied to the upper deflection plate electrode. The kicker pulses change the angle of the input protons so that they are within the acceptance phase space and therefore accelerated in the RFQ. Calculated beam transmission vs. deflection angle at the RFQ entrance show that a deflection angle of only 100 mrad stops the beam from being accelerated. Instead of applying mirror positive and negative DC bias voltages and mirror negative and positive image kicker pulses to the pair of deflection plate electrodes as described above, it is also possible to keep one electrode of the pair of deflection plate electrodes at reference voltage (e.g. 0 volts) and applying the DC bias voltage and kicker pulse to the other one electrode of the pair of deflection plate electrodes. Such variations are within the scope of the invention.

Instead of choosing kicker pulses that will nullify the DC bias across the pair of deflection plate electrodes of FIG. 6 for only a single cycle of the rf current applied to the RFQ linac 30, it is also possible to use longer kicker pulses that will nullify the DC bias across the pair of deflection plate electrodes of FIG. 6 for multiple consecutive cycles of the rf current to pass a selected number of consecutive micropulses at a time and during each or selected ones of the macropulses. This can also be done when the rf current applied to the RFQ linac 30 is continuous instead of intermittently, such as where the longer kicker pulses are applied repetitively. The longer pulses may be applied periodically if desired.

Finally, it is also possible to turn off the dc deflection voltages of ±7 kV applied to the pair of deflection plate electrodes of FIG. 14 and use the kicker pulses of FIG. 14 to remove a number of individual micropulses from the RFQ macropulse. This result can be extended down to removing a single micropulse (5 ns gap) or up to a longer pulse to remove any desired number of pulses. This allows one to create a “notch” in the RFQ output pulse for any time greater than 5 ns. This RFQ kicker design can thus be used to provide a notched input beam for a synchrotron system.

In any one of the above embodiments, desired single or multiple micropulses may be provided by the RFQ linac 30 by applying rf current to the RFQ electrodes and then the kicker pulse or pulses.

Incorporated herein by reference is Chapter 8 in RF Linear Accelerators by Thomas Wangler, and the following two articles: Hamm et al., “A Single Pulse Sub-Nanosecond Proton RFQ, Preprint of Submission to AccApp '11 Meeting, Knoxville, Tenn., Apr. 3-7, 2011, 7 pages; and Zografos et al., “Engineering Prototype for a Compact Medical Dielectric Wall Accelerator,” 8 pages.

The two articles above are included as two appendices attached hereto and made a part of this application.

While the invention has been described above by reference to various embodiments, it will be understood that changes and modifications may be made without departing from the scope of the invention, which is to be defined only by the appended claims and their equivalents.

1. An apparatus providing sub-nanosecond single ion beam pulses, comprising:
an ion source;
a radio frequency quadrupole linear accelerator comprising electrodes;
a power source applying radio frequency alternating current to the electrodes;
a device injecting ions from the ion source to the accelerator, causing the accelerator to provide only a single sub-nanosecond output beam pulse at a time.

2. The apparatus of claim 1, wherein the device injects ions from the ion source to the accelerator within substantially only at least single cycle of the alternating rf current.

3. The apparatus of claim 2, the ion source supplying an ion beam, the device comprising:
a deflection mechanism that deflects ions in an ion beam from the ion source away from the accelerator; and
a circuit that controls the deflection mechanism so that the deflection mechanism does not deflect ions in the ion beam away from the accelerator within substantially only the at least one single cycle of the alternating rf current within a predetermined time interval.

4. The apparatus of claim 3, wherein the device injects ions at instances between time intervals from the ion source to the accelerator, causing the accelerator to provide a sequence of sub-nanosecond output beam pulses that are spaced apart in time.

5. The apparatus of claim 4, wherein power source applying radio frequency alternating current continuously to the electrodes, and the circuit controls the deflection mechanism so that the deflection mechanism does not deflect ions in the ion beam away from the accelerator only within individual cycles of the alternating rf current.

6. The apparatus of claim 4, wherein the deflection mechanism does not deflect ions in the ion beam away from the accelerator within individual cycles of the alternating rf current that occur periodically at a repetition frequency, causing the accelerator to provide the sequence of sub-nanosecond output beam pulses at said repetition frequency.

7. The apparatus of claim 3, wherein said deflection mechanism comprises a pair of conductive deflection plates, and said circuit applies a DC voltage across the plates to deflect ions in the ion beam away from the accelerator.

8. The apparatus of claim 7, wherein said power source includes a clock that controls the timing of the cycles of the alternating currents, and said circuit applying an opposite voltage to said DC voltage to the pair of conductive deflection plates to nullify the DC voltage during the single cycle of the alternating currents in response to a signal from the clock.

9. The apparatus of claim 4, the power source applying radio frequency alternating current to the electrodes only within individual time intervals that occur periodically, wherein the circuit controls the deflection mechanism so that the deflection mechanism does not deflect ions in the ion beam away from the accelerator only within substantially only a single cycle within each of the periodic time intervals.

10. The apparatus of claim 2, said device operating in synchronism with said radio frequency alternating currents from the power source so that said device injects ions from the ion source to the accelerator within substantially only the single cycle of the alternating currents.

11. The apparatus of claim 10, wherein said power source includes a clock, and said device operates in synchronism with said clock.

12. The apparatus of claim 1, wherein the accelerator provides a single pulse of less than 400 picoseconds in pulse width.

13. The apparatus of claim 1, wherein the accelerator provides a single pulse of less than 300 picoseconds in pulse width.

14. The apparatus of claim 1, wherein the accelerator electrodes includes four stages: a matching stage, a shaping stage, a bunching stage and an accelerating stage and said stages cause bunching of the ions passing through the accelerator to provide a single output beam pulse of less than 300 picoseconds in width.

15. The apparatus of claim 14, said accelerating stage having an input end and an output end wherein a vane modulation of the accelerating stage in the accelerator increases from the input end to the output end.

16. The apparatus of claim 1, further comprising a low energy beam transport between the ion source and the accelerator for transporting ions from the ion source to the accelerator, said beam transport comprising two positively biased electrodes separated from one another by an electrode at ground potential.

17. The apparatus of claim 1, further comprising a low energy beam transport between the ion source and the accelerator for transporting ions from the ion source to the accelerator, said beam transport comprising biased electrodes or magnet to transport and focus the beam into the accelerator.

18. A method for providing sub-nanosecond single ion beam pulses, by means of an apparatus comprising an ion source and a radio frequency quadrupole linear accelerator comprising electrodes; said method comprising:
applying radio frequency alternating current to the electrodes;
injecting ions from the ion source to the accelerator, causing the accelerator to provide only a single sub-nanosecond output beam pulse at a tune.

19. The method of claim 18, wherein the injecting injects ions from the ion source to the accelerator within substantially only at least a single cycle of the alternating rf current.

20. The method of claim 19, the ion source supplying an ion beam, the apparatus further comprising a deflection mechanism that deflects ions in an ion beam from the ion source away from the accelerator; and said injecting controls the deflection mechanism so that the deflection mechanism does not deflect ions in the ion beam away from the accelerator within substantially only the at least one single cycle of the alternating rf current within a predetermined time interval.

21. The method of claim 21, wherein the injecting injects at instances between time intervals ions from the ion source to the accelerator, causing the accelerator to provide a sequence of sub-nanosecond output beam pulses that are spaced apart in time.

22. The apparatus of claim 7, wherein said circuit applies a positive DC voltage to a first plate of the plates of the pair of conductive deflection plates, and a negative DC voltage to a second plate of the pair of conductive deflection plates to deflect the ion beam away from the accelerator, and said circuit applies a negative voltage pulse to the first plate and a positive voltage pulse to the second plate to nullify the DC voltages at the pair of conductive deflection plates, so as to let ions from the ion source pass to the accelerator.

23. An apparatus providing sub-nanosecond ion beam pulses, comprising:
an ion source;
a radio frequency quadrupole linear accelerator comprising electrodes;
a power source applying radio frequency alternating current to the electrodes within at least one time interval;
a device injecting ions from the ion source to the accelerator, causing the accelerator to provide a selected number of consecutive sub-nanosecond output beam pulses at a time within said at least one time interval;
said device comprising a deflection mechanism that deflects ions in an ion beam from the ion source away from the accelerator and a circuit that controls the deflection mechanism so that the deflection mechanism does not deflect ions in the ion beam away from the accelerator within substantially only said selected number of consecutive cycles of the alternating rf current.

24. The apparatus of claim 23, the power source applying radio frequency alternating current to the electrodes only within individual time intervals that occur periodically, wherein the circuit controls the deflection mechanism so that the deflection mechanism does not deflect ions in the ion beam away from the accelerator only within substantially only said selected number of consecutive cycles of the alternating rf current within each of the periodic time intervals.

25. A method providing sub-nanosecond ion beam pulses, using an apparatus comprising an ion source and a radio frequency quadrupole linear accelerator comprising electrodes; said method comprising
applying radio frequency alternating current to the electrodes within at least one time interval;
injecting ions by means of a device from the ion source to the accelerator, causing the accelerator to provide a selected number of consecutive sub-nanosecond output beam pulses at a time within said at least one time interval;
said device comprising a deflection mechanism that deflects ions in an ion beam from the ion source away from the accelerator; said method further comprising
controlling the deflection mechanism so that the deflection mechanism does not deflect ions in the ion beam away from the accelerator within substantially only said selected number of consecutive cycles of the alternating rf current.

26. The method of claim 25, wherein said applying source applies radio frequency alternating current to the electrodes only within individual time intervals that occur periodically, and the controlling controls the deflection mechanism so that the deflection mechanism does not deflect ions in the ion beam away from the accelerator only within substantially only said selected number of consecutive cycles of the alternating rf current within each of the periodic time intervals.

27. An apparatus providing sub-nanosecond ion beam pulses, comprising:
an ion source;
a radio frequency quadrupole linear accelerator comprising electrodes;
a power source applying radio frequency alternating current to the electrodes within at least one time interval;
a device injecting ions from the ion source to the accelerator, causing the accelerator to provide consecutive sub-nanosecond output beam pulses within said at least one time interval;
said device comprising a deflection mechanism that deflects ions in an ion beam from the ion source away from the accelerator within substantially only a selected number of consecutive cycles of the alternating rf current, so that a substantially continuous sequence of consecutive sub-nanosecond output beam pulses within said at least one time interval is provided by the accelerator except for the selected number of consecutive cycles of the alternating rf current within said at least one time interval.

28. The apparatus of claim 27, the power source applying radio frequency alternating current to the electrodes only within individual time intervals that occur periodically, wherein the deflection mechanism deflects ions in an ion beam from the ion source away from the accelerator within substantially only said selected number of consecutive cycles of the alternating rf current within each of the periodic time intervals.

29. A method providing sub-nanosecond ion beam pulses, comprising:
an ion source and a radio frequency quadrupole linear accelerator comprising electrodes; said method comprising:
applying radio frequency alternating current to the electrodes within at least one time interval;
injecting ions from the ion source to the accelerator, causing the accelerator to provide consecutive sub-nanosecond output beam pulses within said at least one time interval;
deflecting ions in an ion beam from the ion source away from the accelerator within substantially only a selected number of consecutive cycles of the alternating rf current, so that a substantially continuous sequence of consecutive sub-nanosecond output beam pulses within said at least one time interval is provided by the accelerator except for the selected number of consecutive cycles of the alternating rf current within said at least one time interval.

30. The method of claim 29, wherein the applying applies radio frequency alternating current to the electrodes only within individual time intervals that occur periodically, wherein the deflecting deflects ions in an ion beam from the ion source away from the accelerator within substantially only said selected number of consecutive cycles of the alternating rf current within each of the periodic time intervals.
